(19) United States
(12) Patent Application Publication
(10) Pub. No.: US 2026/0356124 A1
(43) Pub. Date: Nov. 12, 2026

(54) OMNIDIRECTIONAL TWIN WHEEL

(71) Applicant: Gerhard Schubert GmbH, Crailsheim (DE)

(72) Inventor: Felix Henn, Crailsheim (DE)

(73) Assignee: Gerhard Schubert GmbH, Crailsheim (DE)

(21) Appl. No.: 19/662,400

(22) Filed: Apr. 29, 2026

(30) Foreign Application Priority Data
May 8, 2025 (DE) 10 2025 117 767.8

(51) Int. Cl. B60B 33/04; B60B 33/00

(52) U.S. Cl. CPC B60B 33/04; B60B 33/0044; B60B 33/0049

(57) ABSTRACT

Disclosed is an omnidirectional twin wheel with a first and a second suspension axis coupled to each other for common rotation and aligned parallel to a driving surface, a first and a second fork coupled to the associated suspension axis in a rotationally fixed manner, and a first and a second spherical-ring-shaped roller each coupled to the associated suspension axis via the first and second fork, respectively, in such a way that respective centers of the rollers are aligned with an extension of the corresponding suspension axis. Also disclosed is a wheel arrangement with at least three such twin wheels and also a vehicle with at least one such twin wheel.

### CROSS REFERENCE TO RELATED APPLICATION

This application claims priority to German Patent Application No. 10 2025 117 767.8, filed in Germany on May 8, 2025, the entire contents of which are hereby incorporated herein by this reference.

### FIELD

The present invention relates to an omnidirectional twin wheel, a wheel arrangement comprising at least three such twin wheels, and a vehicle comprising at least one such twin wheel.

### BACKGROUND

Various designs of omnidirectional wheels have been used recently, in particular for driving and maneuvering robots that are intended to be characterized by a high degree of mobility. One example of this are wheels which in turn are provided with several individually drivable rollers on their circumference in order to cover as much of the circumference as possible. Since both the wheel itself around its hub and the rollers provided on its circumference can be driven individually and independently for a respective rotation, an omnidirectional movement of the device equipped with such a wheel can consequently be achieved by superimposing the wheel rotation and the roller rotation.

The rollers arranged on the circumference of such wheels can be positioned in various ways, for example side by side, at an angle to one another, alternating in several planes, interlocking by means of curved spherical frustums, or by alternating sizes of the rollers, or also as spherical segments around a central axis.

In this context, however, different problems arise depending on the specific design, since either the circumference of the corresponding wheel cannot be completely covered, which can lead to undefined and incomplete transitions during rolling, or since in other designs the rollers do not run in a single plane, which can lead to an overdefinition of the main axis of rotation, for example in a conventional circular wheel arrangement in omnidirectional vehicles. Furthermore, such omnidirectional wheels generally have a large overall size, among other things due to the necessary bearing of the numerous rollers provided on their circumference.

In addition, with the types of motors and speeds typically employed, the provision of an additional gear stage when using such wheels is practically always necessary. Furthermore, such wheels are complex in construction and comprise a large number of structural components, which is explained, among other things, by the large number of rollers on their circumference, each of which must be individually mounted and driven.

For example, an omnidirectional twin wheel is known from U.S. Pat. No. 9,573,416 B1, which has a bearing arrangement in which the corresponding rollers are mounted in a complex manner with respect to one another. Although such a design of a twin wheel can have, among other things, a reduced overall height compared to the omnidirectional wheels already described, a large number of components still have to be provided and the construction and maintenance of corresponding devices are consequently complex.

Accordingly, there is a need for an improved design of an omnidirectional wheel device which, on the one hand, is constructed in a simple manner with few components and requires a relatively small installation space, while on the other hand providing reliable and smooth operation with uniform rolling at all times.

### SUMMARY

To solve this problem and to overcome the above-described disadvantages of the known prior art, an omnidirectional twin wheel is proposed according to the invention, comprising a first and a second suspension axis coupled to each other for common rotation, which are aligned parallel to a driving surface, a first and a second fork, which are each coupled to the associated suspension axis in a rotationally fixed manner, a first and a second spherical-ring-shaped roller, which are each coupled to the associated suspension axis via the first and second fork, respectively, in such a way that respective centers of the rollers are aligned with an extension of the corresponding suspension axis, wherein each of the rollers is supported by the associated fork so as to be freely rotatable about a cylinder axis, wherein the cylinder axes of the first and second rollers are substantially perpendicular to each other and lie in the plane perpendicular to the suspension axes, and the lateral surfaces of the rollers each cover an angle of at least 90° and the forks in the region of the cylinder axes are not wider than the rolling circles of the rollers, so that the forks do not come into contact with the driving surface in any orientation.

Accordingly, the twin wheel according to the invention is characterized in that the respective angle of the lateral surfaces of the rollers, which amounts to more than ninety degrees, always covers a rolling movement without any gaps and thus enables a smooth transition even when one of the rollers is not currently in contact with the ground, since the associated fork is momentarily in a corresponding angular orientation. Furthermore, the rollers can lie on a common pitch circle so that no overdefinition exists, and since the corresponding twin wheel has only two rollers and a simply constructed suspension, only a few individual components and thus wear parts are provided. In general, it should also be noted that embodiments are conceivable in which the forks support the respective roller from both opposite sides, as well as embodiments in which the forks extend on only one side of the corresponding roller in order to support it.

A further advantage is that the diameter of the rollers can correspond to a diameter of the above-described omnidirectional wheels from the prior art and thus a smaller overall diameter can be achieved with the same load-bearing capacity. Furthermore, gear stages can be completely dispensed with or at least smaller gear stages can be used, which also simplifies the construction of the twin wheel according to the invention. Lastly, the truncated pole points of the corresponding rollers can prevent excessive roller speeds from occurring during rotation of the rollers.

Thus, in the twin wheel according to the invention, no wear occurs due to excessive edge loads during transitions between contact of the respective roller with the ground and separation of the roller from the ground, and also no abrasion or relative movement due to speed differences, which can occur in the case of overdefinition. Furthermore, the simple construction with only two rollers can be expected to result in reduced maintenance effort, and due to the relatively small selectable diameter of the rollers, gear stages can be dispensed with in the aforementioned manner when using conventional electric motors. Nevertheless, in practice it has been shown that excellent positioning accuracy can be achieved by means of corresponding twin wheels, since clean rolling on the ground is ensured at all times.

In this regard, it can be provided, among other things, that a gear coupling and/or a toothed belt coupling is used for coupling the first and second suspension axes of the twin wheel according to the invention. This coupling can also already serve as a connection point for a drive unit which is configured to drive the first and second suspension axes synchronously in rotation. Alternatively, however, it would of course also be conceivable to drive the two suspension axes independently of each other by means of separate drive units, so that the angle-related coupling and the correct alignment of the two suspension axes would not have to be ensured mechanically but rather, for example, by means of electronic monitoring means.

Theoretically, it would also be possible to provide an omnidirectional twin wheel according to the invention in a purely free-running manner, i.e., to dispense with a corresponding drive unit. Accordingly, in such a variant of the invention, the twin wheel would merely act as a load wheel assembly.

Furthermore, it is conceivable according to the invention to construct a wheel arrangement from at least three twin wheels of the inventive type just described, in which the twin wheels can be arranged in particular on a circular circumference. By means of a corresponding arrangement, in particular if the twin wheels are spaced apart from each other by an equal angle on the corresponding circular circumference, and suitable actuation of the respective drive unit, any desired direction of travel can be caused and consequently an omnidirectional drive can be achieved.

Accordingly, the present invention also relates to a vehicle which comprises at least one twin wheel according to the invention or a wheel arrangement according to the invention in the manner just described. In this case, each of the twin wheels can comprise a respective dedicated drive unit and a central control unit can furthermore be provided, which is configured to control the respective drive units of the twin wheels in a coordinated manner. By driving the respective suspension axes of the rollers of the twin wheels of the wheel arrangement at different speeds either clockwise or counterclockwise, any desired movement of a corresponding vehicle can be caused, including straight-ahead travel, rotation on the spot, and rotation about an arbitrarily oriented point outside the vehicle.

### BRIEF DESCRIPTION OF THE DRAWINGS

Further features and advantages of the present invention will become even more apparent from the following description when considered together with the accompanying figures. These show in particular:

FIGS. 1a and 1b an isometric view and a front view of an omnidirectional twin wheel according to the invention;

FIG. 2 a schematic representation of the twin wheel from FIGS. 1a and 1b;

FIGS. 3a and 3b a schematic front view and top view, respectively, of the rollers of the twin wheel from FIGS. 1a, 1b, and 2;

FIGS. 4a and 4b two front views of the rollers from FIGS. 3a and 3b to illustrate a rolling process;

FIG. 5 a wheel arrangement according to the invention in a schematic top view as part of a vehicle according to the invention; and

FIGS. 6a to 6c schematic top views to illustrate different forms of movement of the wheel arrangement from FIG. 5.

### DETAILED DESCRIPTION

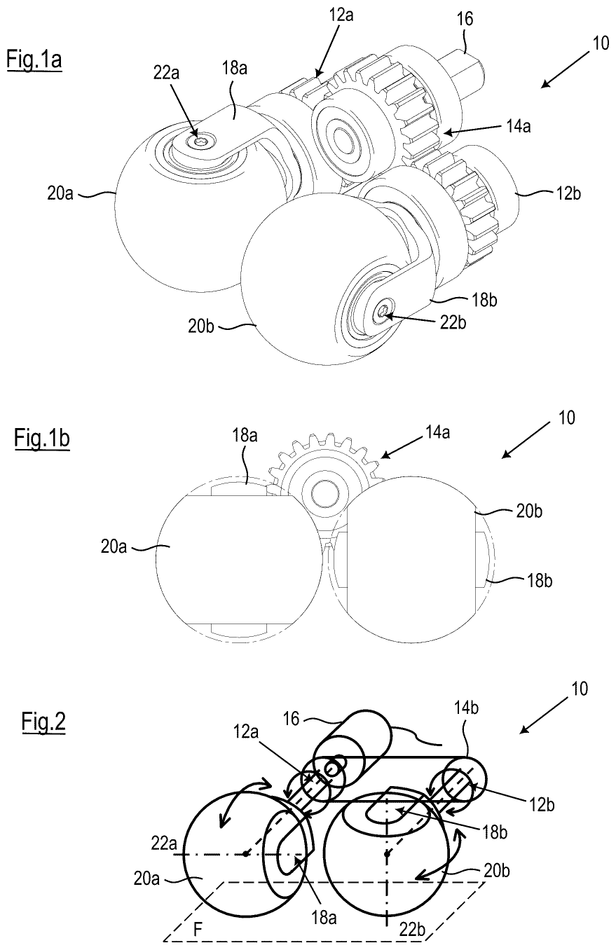

In FIGS. 1a and 1b, an omnidirectional twin wheel according to the invention is first shown in an isometric view and a front view. The components of this twin wheel can be manufactured using any suitable materials, for example metallic materials or sufficiently hard plastics. Furthermore, reference is also already made to FIG. 2, which shows the twin wheel again in a schematic representation from a similar perspective to the representation of FIG. 1a, in order to be able to illustrate the individual components thereof together with their respective mode of operation.

In these figures, the twin wheel according to the invention is designated in each case by the reference numeral 10 and it comprises a first and a second suspension axis 12a and 12b, which are each aligned parallel to a driving surface F. The first and second suspension axes 12a, 12b are coupled to each other via a mechanical coupling for common rotation, the corresponding coupling being shown in FIGS. 1a and 1b as a gear coupling 14a and in FIG. 2 as a toothed belt coupling 14b. The corresponding coupling 14a or 14b in each case also already serves as a connection point for a schematically depicted drive unit 16 in the form of a suitable electric motor, which is configured to drive the suspension axes 12a, 12b synchronously in rotation via the respective coupling 14a or 14b.

Here, a first and a second fork 18a, 18b are coupled to the respectively associated suspension axis 12a, 12b in a rotationally fixed manner. These forks 18a, 18b in turn support first and second spherical-ring-shaped rollers 20a, 20b from the outside in such a way that they extend laterally in the region of a flattened part of these rollers 20a, 20b and in this region a respective cylinder axis 22a, 22b is arranged for free-running support of the corresponding rollers 20a, 20b on the forks 18a, 18b. In particular, it can be seen in FIG. 1b and it is illustrated by dashed circles that the forks 18a, 18b do not extend beyond the respective rolling circles of the rollers 20a, 20b, or in other words, are not wider in the region of the cylinder axes 22a, 22b than said rolling circles.

Furthermore, it can be seen that the cylinder axes 22a and 22b of the first and second rollers 20a, 20b are perpendicular to each other and also lie in the plane perpendicular to the two suspension axes 12a, 12b. It should also be noted that the respective centers of the rollers 20a, 20b lie in the extensions of the corresponding suspension axes 12a, 12b.

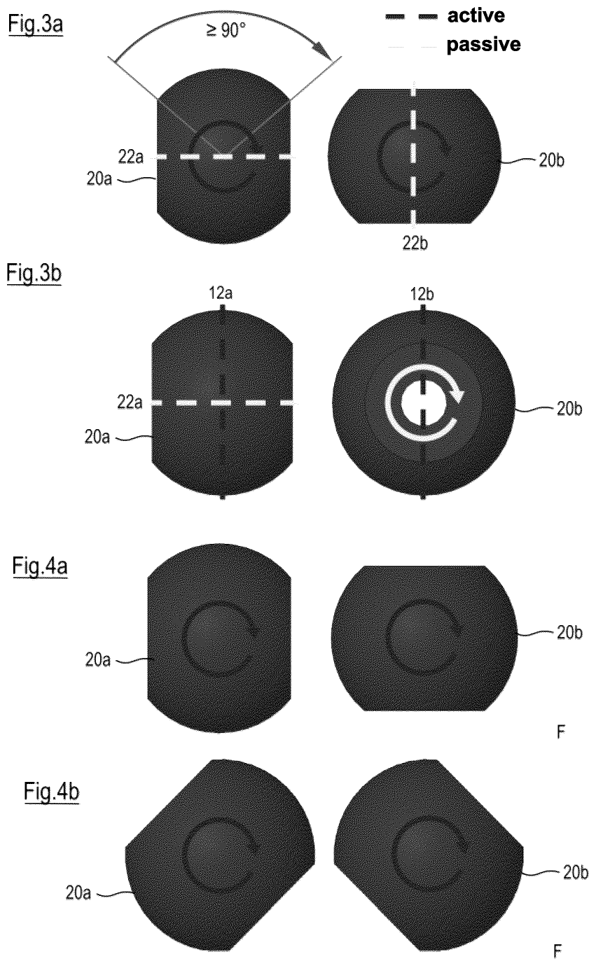

In FIGS. 3a and 3b, the two rollers 20a, 20b are first shown once again as a pair in a front view and a top view, respectively, in order on the one hand to further illustrate their external shape and on the other hand to place the respective axes in relation to the corresponding views. In particular, it can be seen that, as indicated in FIG. 3a, the lateral surfaces of the rollers 20a, 20b cover an angle of at least ninety degrees, wherein it was already apparent in FIG. 1b that the forks 18a and 18b in the region of the cylinder axes 22a, 22b are not wider than the rolling circles of the rollers 20a, 20b, so that, for example, even in the position shown in FIG. 2, the corresponding fork 18b of the roller 20b shown on the right will not come into contact with the driving surface F.

Furthermore, it can be seen in FIGS. 3a and 3b that, in accordance with the caption contained in the figure, passive axes are present on the one hand, i.e., free rotation of the corresponding roller 20a, 20b about the cylinder axis 22a or 22b is enabled in each case, while a corresponding active drive of the rollers about the axes likewise shown as active, or in accordance with the circles depicted as such, is achieved by means of the drive unit 16 and the transmission via the coupling 14a or 14b and the forks 18a, 18b.

Furthermore, reference is made to FIGS. 4a and 4b, which in a front view corresponding to the representation of FIG. 3a schematically illustrate the rolling of the rollers 20a, 20b of the twin wheel 10 according to the invention during driving by the drive unit 16 by means of circular arrows. The representation of FIG. 4a shows that initially only the roller 20a shown on the left rests on the ground in the region of its lateral surface, while the roller 20b shown on the right points with its flattened region in the direction of the driving surface F, where, however, the narrowly designed fork 18b, not shown here for reasons of clarity, is present, which does not come into contact with the ground F due to its construction and the angular coverage of the lateral surface of the roller 20b.

When the rolling movement is then caused by operation of the drive unit 16 and the state of FIG. 4b is accordingly assumed after a certain time, it can be seen that in this angular orientation of the two rollers 20a, 20b, they each rest with a section of their lateral surfaces on the driving surface F, so that during a further transition in this direction, the roller 20a shown on the left will lose contact with the ground, but the roller 20b shown on the right can roll on its lateral surface in this direction. Accordingly, at least one of the rollers 20a, 20b is always in contact with the driving surface F and smooth rolling of the twin wheel 10 as a whole is ensured at all times.

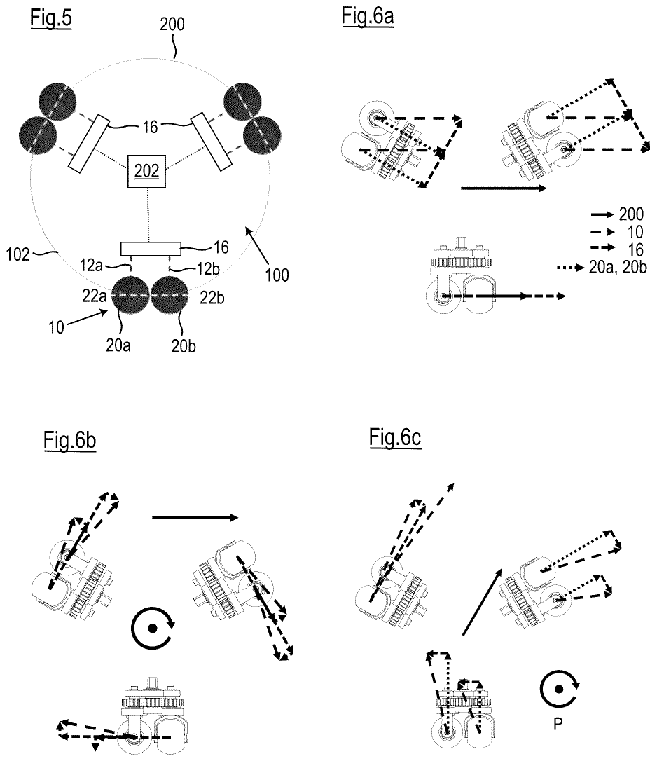

Reference is also made to FIG. 5, which shows a wheel arrangement 100 according to the invention, in which three twin wheels 10 according to the invention are arranged on a circular circumference 102 and are each spaced apart from one another by an equal angle of 120°. The wheel arrangement 100 can be arranged on the underside of an omnidirectionally movable vehicle 200 not further shown, for example an autonomously operable robot or the like.

The active and passive axes of the respective rollers 20a, 20b of the twin wheels 10 are again shown in order to illustrate the orientation thereof in relation to the driving surface located beneath the wheel arrangement 100. Furthermore, each of the twin wheels 10 can comprise its own respective drive unit 16, which is suitably coupled to a schematically depicted central control unit 202 of the vehicle 200 and can be actuated for operation.

Exemplary modes of operation for different forms of travel of the corresponding vehicle 200 by means of the wheel arrangement 100 are lastly explained below with reference to FIGS. 6a to 6c.

In each case, according to the caption shown in these figures, a movement of the vehicle 200 as a whole is depicted, as well as the drive direction of the respective drive unit 16, the direction of movement of the respective twin wheels 10, and the passive rolling movements of the individual rollers 20a, 20b. It should be noted that each of the twin wheels 10 can be individually controlled in a differential manner, i.e., in two opposite directions, clockwise or counterclockwise, and with variable rotational speed.

In particular, FIG. 6a corresponds to a linear straight-line movement of the vehicle 200 to the right, FIG. 6b to a rotation of the vehicle on the spot, and FIG. 6c to a rotation of the vehicle 200 about a point P located outside the vehicle 200.

Accordingly, it can be seen that by suitable differential actuation of the three drive units 16, either clockwise or counterclockwise, all of these forms of movement of the vehicle 200 can be achieved, so that overall an omnidirectional behavior of the vehicle 200 can be achieved with the aid of the three twin wheels 10 and by suitable actuation of their respective drive units 16 by means of the central control unit 202 of the vehicle 200.

1. An omnidirectional twin wheel, comprising:
a first and a second suspension axis coupled to each other for common rotation, which are aligned parallel to a driving surface;
a first and a second fork, which are each coupled to the associated suspension axis in a rotationally fixed manner; and
a first and a second spherical-ring-shaped roller, which are each coupled to the associated suspension axis via the first and second fork, respectively, in such a way that respective centers of the rollers are aligned with an extension of the corresponding suspension axis,
wherein each of the rollers is supported by the associated fork so as to be freely rotatable about a cylinder axis,
wherein the cylinder axes of the first and second rollers are substantially perpendicular to each other and lie in the plane perpendicular to the suspension axes, and
wherein the lateral surfaces of the rollers cover an angle of at least 90° and the forks in the region of the cylinder axes are not wider than the rolling circles of the rollers, so that the forks do not come into contact with the driving surface in any orientation.

2. The twin wheel according to claim 1,
wherein a gear coupling or a toothed belt coupling is provided for coupling the first and second suspension axes.

3. The twin wheel according to claim 1,
further comprising a drive unit which is configured to drive the first and second suspension axes synchronously in rotation.

4. A wheel arrangement comprising at least three twin wheels according to claim 1.

5. The wheel arrangement according to claim 4,
wherein the twin wheels are arranged on a circular circumference.

6. The wheel arrangement according to claim 5,
wherein the twin wheels are each spaced apart from one another on the circular circumference by an equal angle.

7. A vehicle comprising at least one twin wheel according to claim 1.

8. The vehicle according to claim 7,
comprising a wheel arrangement comprising at least three twin wheels.

9. The vehicle according to claim 8,
wherein each of the twin wheels comprises a respective drive unit.

10. The vehicle according to claim 9,
further comprising a central control unit which is configured to control the drive units of the twin wheels in a coordinated manner.

11. The vehicle according to claim 8,
wherein the twin wheels are arranged on a circular circumference.

12. The wheel arrangement according to claim 11,
wherein the twin wheels are each spaced apart from one another on the circular circumference by an equal angle.
